(19) United States
(12) Patent Application Publication
(10) Pub. No.: US 2015/0348075 A1
(43) Pub. Date: Dec. 3, 2015

(54) COMMUNITY UTILIZATION MODELS

(71) Applicant: Noble Analytics & Consulting, LLC, Brentwood, TN (US)

(72) Inventors: Wilson H. Hensley, III, Nolensville, TN (US); Daniel L. DeFelice, Nashville, TN (US)

(73) Assignee: Noble Analytics & Consulting, LLC, Brentwood, TN (US)

(21) Appl. No.: 14/292,520

(22) Filed: May 30, 2014

(51) Int. Cl. G06Q 30/02; G06F 19/00; G06F 17/30

(52) U.S. Cl. CPC G06Q 30/0205; G06F 17/30867; G06F 19/324; G06Q 30/0204

(57) ABSTRACT

Specialty healthcare in a community is analyzed by calculating an average number of cases in a region which includes and is larger than the community, calculating an expected number of cases for the community based on the average, and comparing the expected number of cases to a number of actual cases for the community. The community may be a contiguous service area surrounding a hospital, and the region is a state containing the service area. Cases can be filtered according to patient demographics, such as age, and in particular the analysis can be tailored for Medicare. The analysis results in a community utilization differential which is divided by physician productivity to determine an actual number of specialty physicians needed for the community. The cases may be based in part on services performed by non-doctor healthcare professionals, but the physician productivity is based on a physician count which excludes such professionals.

### BACKGROUND OF THE INVENTION

1. Field of the Invention

The present invention generally relates to healthcare management, and more particularly to a method of evaluating physician needs for a community.

2. Description of the Related Art

As healthcare costs continue to rise, it becomes increasingly important to efficiently manage healthcare resources. In particular, the demand for skilled medical practitioners is higher than ever. Studies have been commissioned to provide recommendations on how to improve physician availability, particularly in specialty areas. Proposed solutions include a variety of policy decisions such as payment for services, other monetary incentives, and constraints on residency slots.

While these approaches help improve physician capacity, they do not provide any guidance on where the need for a given specialty is the greatest. Hospitals in particular are eager to recruit physicians to fill important gaps in healthcare services for their surrounding communities. However, hospitals and other healthcare organizations have run afoul of certain U.S. laws and regulations when trying to establish policies for physician recruitment. In order to limit opportunities for fraud, rules have been enacted which constrain various terms of physician recruitment such as remuneration and referrals. Most of these rules stem from the Anti-Kickback statute (42 U.S.C. §1320a-7b), and the Stark law (42 U.S.C. §1395nn).

In an attempt to strike a balance between legitimate recruitment efforts and abusive payments, the Stark law creates a recruitment exception if a hospital can establish a community need for a particular specialist. The physician recruitment exception is designed to protect certain remuneration that is provided by a hospital to a physician as an inducement for the physician to relocate his or her medical practice into the geographic area served by the hospital. A hospital may undertake a community needs analysis (CNA) to prove such a need. Rules implementing the Stark law provide various definitions and restrictions and how a CNA is to be performed. For example, the Stark regulations define the geographic service area (GSA) for the hospital as the area composed of the lowest number of contiguous postal ZIP codes from which the hospital (client) draws at least 75% of its inpatients (90% for rural hospitals). A physician must relocate his or her practice from a location outside of the GSA to a location inside the GSA to take advantage of the exception.

In addition to the Stark CNA requirement, the Patient Protection and Affordable Care Act (PPACA) requires not-for-profit hospitals to carry out a community healthcare needs assessment (CHNA) every three years to maintain their tax exempt status. The hospitals must adopt an implementation strategy to meet the needs identified through the CHNA, and report how they are addressing those needs.

Neither the Stark law nor the Anti-Kickback statute (AKS) expressly require a community needs assessment associated with the Stark exception or AKS safe harbor for physicians recruited by hospitals. However, for arrangements that fall outside the AKS safe harbor (i.e., 75% of the impacted patients do not reside in a health professional shortage area or medically underserved area), the Office of Inspector General (OIG) will look to whether the recruiting hospital possesses documentary evidence of an objective need for the recruited physician's services. Specifically, the OIG has recognized that, while a defined GSA to which a practitioner is recruited will most likely represent documented evidence of an objective need for the practitioner's services, even when an area is not designated as a health professional shortage area it may still be deficient with respect to a particular specialty. To this end the OIG will consider the validity of other documented evidence of an objective need on a case-by-case basis, generally deferring to community need findings described by the Internal Revenue Service in various Revenue Rulings on the subject, such as Revenue Ruling 97-21. Although the IRS has not issued specific requirements for demonstration community need, examples may include: (i) a documented physician-to-patient ratio in the community demonstrating a deficiency in the particular specialty of the recruited physician; (ii) demand for an existing or new medical service in the community, coupled with a documented lack of availability of the service or long waiting periods for the service, along with evidence that the recruited physician will increase availability of that service; (iii) a documented lack of physicians serving indigent or Medicaid patients within Hospital's service area, provided that the recruited physician commits to serving a substantial number of Medicaid and charity care patients; (iv) a reasonably expected reduction in the number of physicians in a recruited physician's specialty serving the hospital's service area due to the anticipated retirement within the next three to five year period of such physicians presently in the community, and for which such reduction will result in a community need as identified in the foregoing; and (vi) either documentation that a recruited physician is being recruited to serve a community designated as a health professional shortage area (or another designated medically underserved area at the time the Recruitment Agreement is executed), or other specific evidence of community need as identified in the hospital's medical staff development plan as recommended by the hospital's physician executive in collaboration with legal counsel and as approved by its board.

### SUMMARY OF THE INVENTION

The present invention is generally directed to a method which may be implemented in a computer system or as a program product of analyzing healthcare received in a geographic community for a physician specialty by calculating an average number of cases per person for the specialty in a geographic region which includes and is larger than the geographic community, calculating an expected number of cases for the specialty in the geographic community based on the average number of cases per person for the specialty in the geographic region, and comparing the expected number of cases for the specialty in the geographic community to a number of actual cases for the specialty in the geographic community. The average number of cases per person for the specialty in the geographic region can be calculated by dividing a total number of actual cases for the specialty within the geographic region by a population of the geographic region. The expected number of cases for the specialty in the geographic community can be calculated by multiplying the average number of cases per person for the specialty in the geographic region by a population of the geographic community. In an exemplary embodiment the geographic community is a contiguous service area surrounding a hospital, and the geographic region is a state containing the contiguous service area. The average number of cases per person for the specialty in the geographic region and the expected number of cases for the specialty in the geographic community can be filtered according to at least one patient demographic, such as age.

The comparison may be carried out by subtracting the expected number of cases for the specialty in the geographic community from the number of actual cases for the specialty in the geographic community to yield a community utilization differential. The community utilization differential can then be divided by an average physician productivity for the specialty within the geographic region to determine an actual number of physicians needed for the specialty within the geographic community. In the illustrative implementation, the expected number of cases for the specialty in the geographic community and the number of actual cases for the specialty in the geographic community are based in part on services performed by non-doctor healthcare professionals such as nurse practitioners or physician's assistants, but the average physician productivity is based on a physician count which excludes non-doctor healthcare professionals.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a computer system programmed to carry out community needs analysis in accordance with one implementation of the present invention;

FIG. 2 is a map of Tennessee providing an exemplary geographic service area surrounding a hypothetical hospital with equations for determining physician need for the service area (community) in accordance with one implementation of the present invention;

FIG. 3 is a chart depicting one manner of implementing a community needs utilization model in accordance with the present invention;

FIG. 4 is a chart showing the dataflow for the community needs utilization model of FIG. 3 in accordance with one implementation of the present invention; and

FIG. 5 is a chart illustrating the logical flow for a community needs assessment process in accordance with one implementation of the present invention.

The use of the same reference symbols in different drawings indicates similar or identical items.

### DESCRIPTION OF THE PREFERRED EMBODIMENT(S)

As explained in the Background section, there are a variety of reasons that a healthcare organization such as a hospital might want to assess the needs for particular physician specialties in a surrounding community, such as a defined geographic service area (GSA). However, there are several deficiencies with the current approaches to evaluating such needs. The standard physician-to-population ratio commonly used to determine physician needs assumes all physicians are the same and every community has the same healthcare needs regardless of demographics, but this proposition is flawed for several reasons. The first is because physicians often have more than one office, making it difficult to determine how often a particular physician is serving inside a community. Physicians practicing in multiple locations but only being reported in one location has the effect of punishing the residents of the primary office in a needs analysis while giving the residents of the physician's other locations an unreasonable advantage. Second, physicians will work more or less than the average physician for personal reasons not related to the healthcare needs of the community. A given physician might work less because of age, raising a new family, research the physician is conducting, or just personal preference. Third, the simple physician-to-population ratio ignores that healthcare needs vary from community to community. Finally, it does not account for the fact that people can easily migrate into and out of a community when seeking care.

In light of the foregoing, it would be desirable to devise an improved method of analyzing the medical needs of the people within a community for a provider specialty which could remove such faulty assumptions. It would be further advantageous if the method could more accurately match the level of physician activity in a community to the needs of the people who live there. The present invention addresses these shortcomings by focusing on the actual level of healthcare people receive in the community, compared to the level of healthcare received by the average person in a larger region, such as the state. The goal is to ensure that every community has enough physicians to deliver a level of healthcare which is at least equal to the average level in the state.

This novel analytical approach focuses on these issues in the following ways. First, the community utilization models of the present invention recognize that there is no way to precisely determine the number of physicians in a community because any given physician can practice in several zip codes. This problem is addressed by not basing the needs of a community on a number of physicians, but rather on the healthcare usage of the people in the community. Second, no individual physician's productivity has an impact on the needs of a community for an analysis which follows the present invention. A community's physician need can instead be based on the aggregate activity of all physicians who serve in a community. Third, while a model can control for demographic differences such as age, race, and gender within a community, demographic analysis will not account for differences in environment, lifestyle, and diet. By analyzing the actual cases inside a community the present invention can account for demographic as well as lifestyle differences. Finally, physician-to-population models do not account for occupational or seasonal migration. Comparing the actual number of cases seen to the expected number adjusts physician need for all of these situations.

A community utilization model in accordance with the present invention is not a physician-to-population model. Rather, it was created to address the failings of a physician-to-population model. Physician need should be based on the healthcare needs and usage of a community, and not simply on the number of people who live there or the number of physicians who have one of several practice locations there. The present invention can accordingly calculate by specialty the number of cases an average physician sees in a year and use that number to estimate the number of such physicians required to give the community a level of healthcare equal to the level of the average community in the state. The invention can further look at actual data to see what an average physician's productivity really is, instead of using an estimate of what a physician's productivity “should” be.

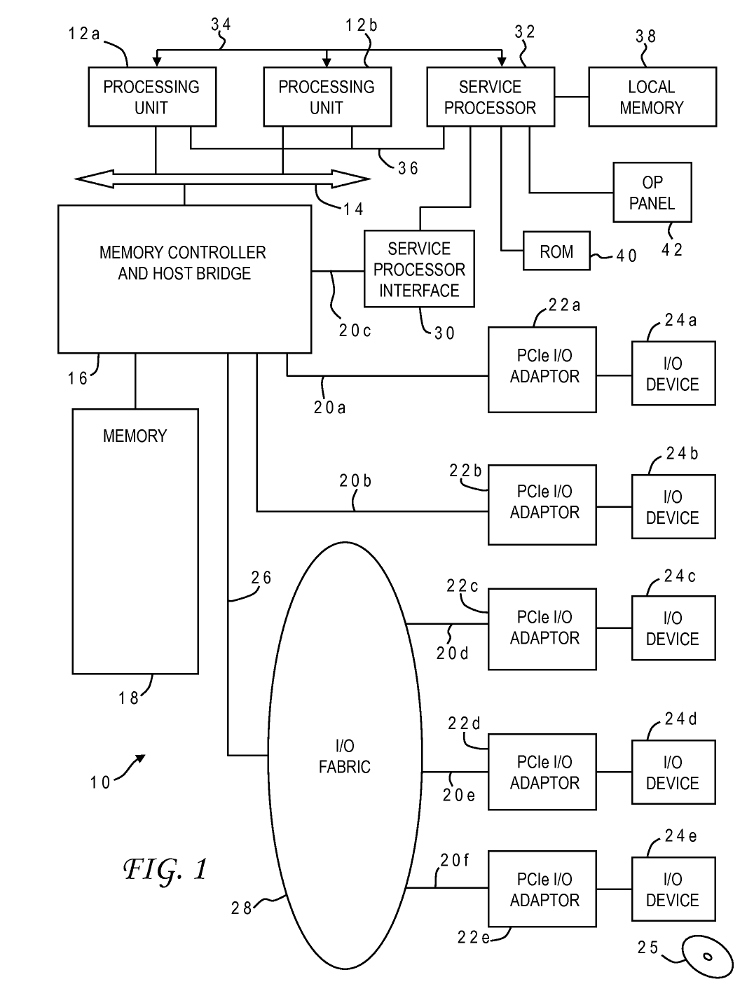

With reference now to the figures, and in particular with reference to FIG. 1, there is depicted one embodiment 10 of a computer system in which the present invention may be implemented to carry out an analysis of the healthcare needs of a community. Computer system 10 is a symmetric multiprocessor (SMP) system having a plurality of processors 12a, 12b connected to a system bus 14. System bus 14 is further connected to and communicates with a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches.

MC/HB 16 also has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f. These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive which receives an optical disk 25 (one example of a computer readable storage medium) such as a CD or DVD, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention. The invention may further be implemented in an equivalent cloud computing network.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the community needs analysis application of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer system 10 carries out program instructions for a community utilization model that uses novel analysis techniques to determine community needs for a particular physician specialty, and may be part of a larger software application used to manage healthcare resources or systems. Accordingly, a program embodying the invention may include conventional aspects of various healthcare management tools, and these details will become apparent to those skilled in the art upon reference to this disclosure.

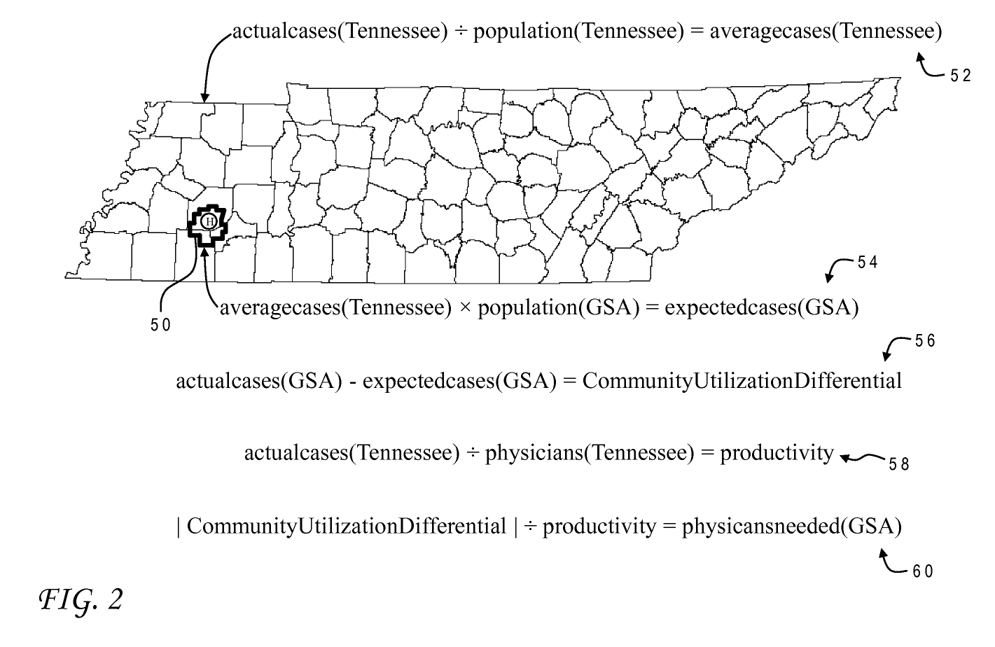

Referring now to FIG. 2, there is depicted a map of the state of Tennessee which is used as one example for implementing the present invention. In this example, there is a hospital “H” located in south-central Madison county, and its surrounding community is considered to be the defined GSA 50 which includes zip code areas in Madison, Chester and Hardeman counties. In this manner the hospital can carry out a Stark-mandated community needs analysis (CNA), but in other implementations the community may be defined in terms other than Stark zip codes as desired. For example, a community might be defined as a county that contains the locus of the analysis. Healthcare data is provided, e.g., by a vendor, for insurance claims for every zip code within the state as well as a full roster of physicians, by specialty, in order to have an accurate count of all practicing physicians within the state. This data may be provided in two files (claims and physicians) formatted to be readable by an I/O or network device of computer system 10 and usable by the software application of the present invention.

Algorithms running on computer system 10 which implement the present invention can compare the expected level of healthcare received in the GSA to the average level of healthcare received in the state by specialty, and optionally by demographic category (such as age, race, and gender). From the data provided, different input values are obtained including the total number of cases by category (for the state and the community), the total population by category (for the state and the community), the total number of cases performed by physicians by specialty by category (for the state and the community), and the total number of practicing physicians by specialty (state only). The definition of “practicing physician” may vary according to application and designer preference; in the illustrative embodiment the model considers any licensed medical doctor (MD) or doctor of osteopathy (DO), but nurse practitioners (NPs), physician's assistants (PAs) and the like (non-doctor healthcare professionals) are not included as practicing physicians based on the belief that the majority of their cases will match the specialty physician that oversees the practice. Claims for services rendered by NPs or PAs are, however, included for case counts. For the preferred embodiment, physicians will only be counted in their primary specialty no matter what kind of cases they see, although alternative embodiments may allow physicians to be considered as practicing in more than one specialty.

Returning to FIG. 2, community utilization models of the present invention can calculate an average number of cases per person for each specialty by dividing the total number of actual cases in the larger region (state) for the specialty over a defined time period by the number of physicians practicing the specialty within the state (equation 52). The defined time period may for example be one year, e.g., the most recent twelve months for which data is available, but other time periods can be used as desired. This average number of cases per person can be used to calculate an expected number of cases for the specialty in the community, by multiplying it with the population of the community (equation 54). The expected number of cases for the community can then be compared to an actual number of cases for the community over the defined time period. In particular, this comparison may comprise subtracting the actual number of cases for the community from the expected number of cases for the community to yield a community utilization differential (56). Physician productivity can further be defined as the actual number of cases for the specialty in the state divided by the number of physicians in the state who practice the specialty (equation 58). Other measures of physician productivity could be used; as data becomes more granular, billing codes such as DRG (diagnosis-related group) and ICD-10 (International Classification of Diseases) can be converted into relative value units to get a more precise measure of how much time physicians spend with patients. In this manner, the number of physicians still needed for the specialty in this community can be determined by dividing the absolute value of the community utilization differential by the average physician productivity for the specialty (equation 60). This number may be round up or down to an integer as desired, but is preferably presented with one decimal place.

Further to the hypothetical example of FIG. 2, the expected number of cases for the GSA 50 of the hospital for a particular specialty is calculated by computer system 10 to be 1,000 cases/year based on the actual number of cases in Tennessee, the population of Tennessee, and the population of the GSA. However, the actual number of cases/year in the GSA for the specialty turns out to be only 800 cases, leaving a differential of 200 cases/year. Physician productivity for this specialty is further calculated to be 100 cases per year per physician, so the community utilization model will report a need for two physicians practicing this specialty for the community.

A variation of the foregoing can be used for Medicare-related physician needs. In this Medicare embodiment, the community utilization model is similar with the exceptions of: (i) carving all population 64 and younger from the state and GSA data, (ii) only counting cases (visits) that have been designated as Medicare claims, and (iii) using a roster of physicians who have accepted one or more Medicare-designated claims. This model is intended to assist communities that are seeing a decrease in the number of physicians accepting Medicare. As reimbursement rates have dropped for Medicare relative to the rates of private insurance providers, the number of physicians serving the Medicare population has decreased. At times this decrease is severe enough to cause a considerable hardship on the Medicare population. A community utilization model for Medicare in accordance with the present invention addresses this issue by examining the level of Medicare activity in a community compared to the activity of the average Medicare user in the state. In the preferred implementation of this model, a physician must commit to serving a substantial number of Medicare users, such as 60% of the physician's case volume. The average number of physicians accepting Medicare patients for the state can be compared to the average for the community. The average number of physicians accepting Medicare patients is defined as the number of physicians accepting Medicare divided by the population over 65. As with the previous model, in the Medicare community utilization model claims rendered by NPs and PAs will be included the NPs and PAs themselves will not be included in the overall physician supply.

The Medicare community utilization model can benchmark and examine the following variables for each specialty: total number of Medicare cases (for the state and the community), the total Medicare population (for the state and the community), the total number of Medicare cases performed by physicians by specialty (for the state and the community), and the total number of physicians by specialty (state only). The average number of Medicare cases per Medicare eligible person in the state is accordingly the number of total Medicare cases in the state divided by the total Medicare population of the state. The number of expected Medicare cases for the community is the average number of Medicare cases per Medicare eligible person in the state multiplied by the community Medicare population. The community utilization Medicare differential can then be calculated as the number of expected Medicare cases for the community less the actual number of Medicare cases in the community. Average physician productivity is still based on the overall number of cases in the state, not limited to Medicare only cases. Average physician productivity must be multiplied by 0.6 (to reflect the 60% case volume for the physician definition), before it is divided into the absolute value of the community utilization Medicare differential to yield a numeric value for the additional physician need for the Medicare community, for this specialty, to ensure the average Medicare user in the community has the same access to service as the average Medicare user in the state.

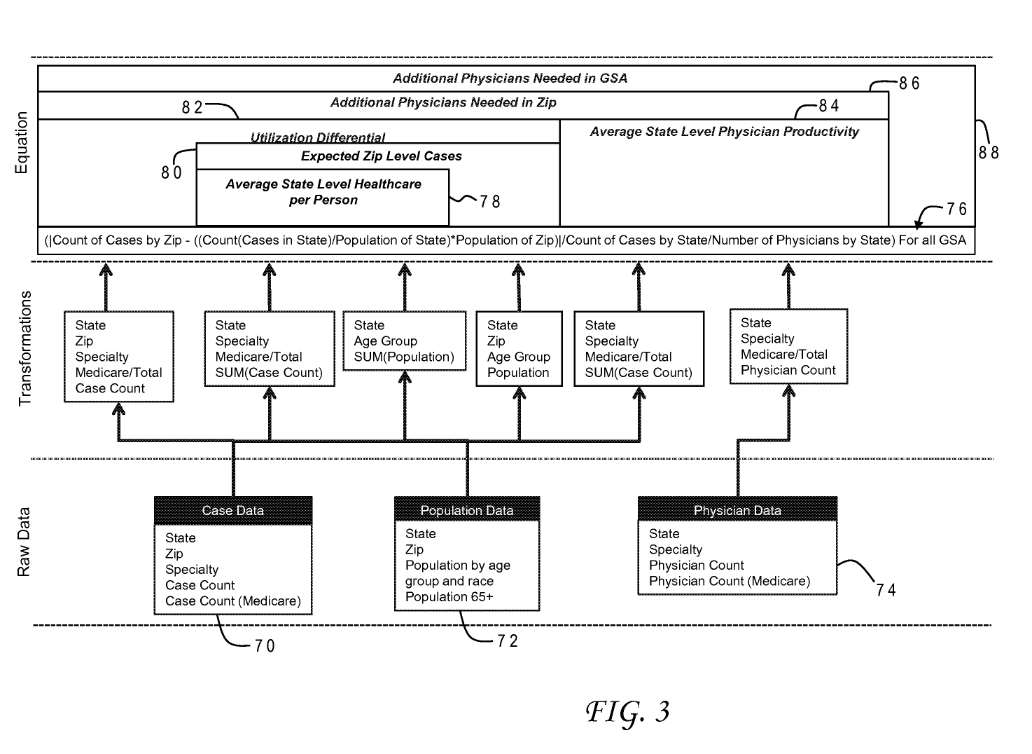

FIG. 3 is a representation of an exemplary community needs utilization model which takes raw data, performs transformations of that data, and then uses the foregoing equations in the different noted contexts. The raw data can include case data 70, population data 72, and physician data 74. Case data 70 covers all cases by zip code for a given state and specialty, with a case count (the number of patient encounters for the specialty), and a Medicare case count. Population data 72 is also provided for the state by zip, with demographic breakdown as available (age, race, gender), and the over 65 years of age population for Medicare needs. Physician data 74 is state only, i.e., no need to break down by zip code, with indications for specialty, an overall physician count for the specialty, and Medicare physician count. These various data are used in certain transformations to provide the necessary parameters for the community utilization model as implemented in the overarching equation 76, which is equivalent to the set of equations shown in FIG. 2. The actual number of cases in the state (“Count(Cases in State)”) is derived from the state tally for total cases in the specialty (or the Medicare total), summing the case counts. The state population (“Population of State”) is derived from the sum of the populations for all of the zip codes in the state, subject to any demographic constraint such as age group. These first two parameters provide the average level of healthcare in the state for the specialty 78. The zip code population (“Population of Zip”) is derived from the populations for each zip code, again subject to any demographic constraint such as age group. This parameter, together with the first two, provides the expected number of cases at the zip level 80. The actual number of cases in a zip code (“Count of Cases by Zip”) is derived from the zip tally for total cases in the specialty (or the Medicate total). These four parameters together result in the community utilization differential 82. The overall physician count in the state for the specialty (“Number of Physicians by State”) is derived from the state physician roster, or Medicare physician roster, for the specialty using the physician count. This latter parameter, combined with the actual number of cases in the state (“Count of Cases by State”), provides the average physician productivity 84. Together, all of these parameters result in the number of physicians needed for any particular combination of zip codes 86. Combining the needs of all zip codes that constitute a particular GSA results in the additional physicians needed for the GSA 88.

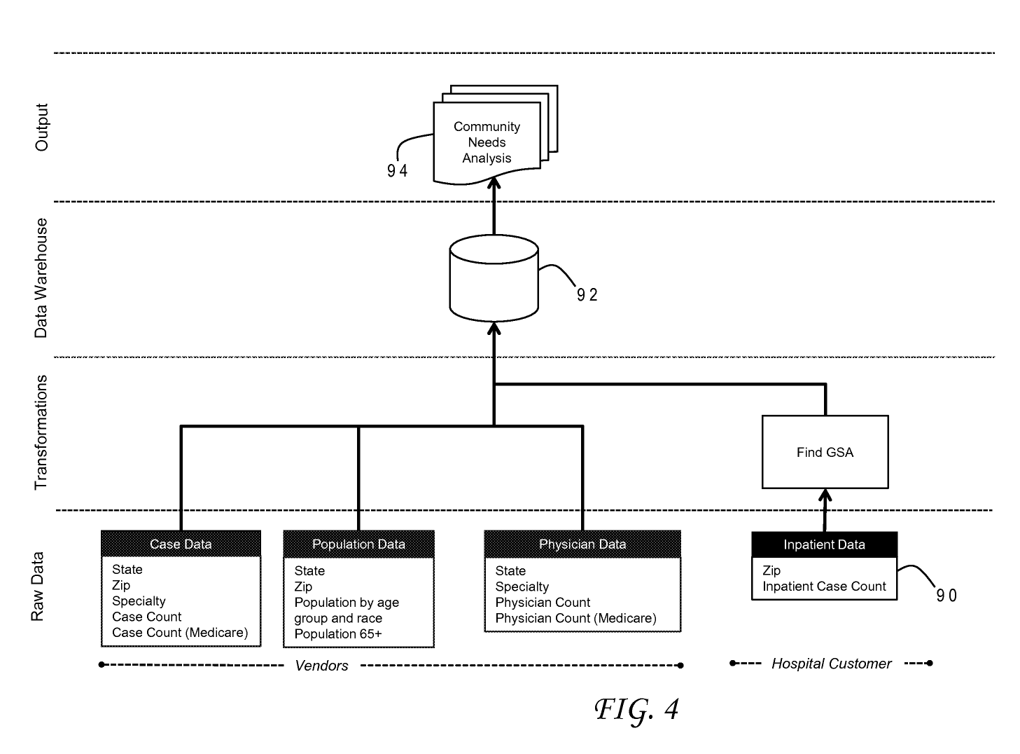

FIG. 4 depicts the data flow for a needs analysis service using one or more community utilization models in accordance with one implementation of the present invention. The data flow again begins with raw data or input files including case data 70, population data 72, physician data 74, and inpatient data 90. The first three of these files are preferably provided by one or more vendors, but can be obtained via other means such as data mining of insurance claims. Inpatient data 90 can be provided by the particular customer, i.e., a hospital or other healthcare entity which is conducting a needs assessment. Multiple customers can access the service via networked computer systems, e.g., the Internet. These data undergo transformations as previously noted, and the inpatient data 90 is used to determine the GSA for the customer, e.g., Stark III. The transformed parameters can be stored in a data warehouse 92 accessible to the customers and other users. Data warehouse 92 may include the software application which provides the community utilization models of the present invention, or that application may run on a separate computer system such as computer system 10 which has access to data warehouse 92. The data warehouse may be administered by a third party or by an agent of the customer(s). The term “data warehouse” as used herein generally refers to a collection of computerized data, organized for reporting or analysis, and may include without limitation one or more databases or an extracted file provided from the data warehouse or its agent. The relevant data is not necessarily stored as intact parameters but rather could be stored as objects or separate data elements that together comprise one or more parameters. The output of data warehouse 92 is a community needs analysis 94 which may include additional information beyond the scope of this invention relating to the healthcare entity, patient statistics, etc.

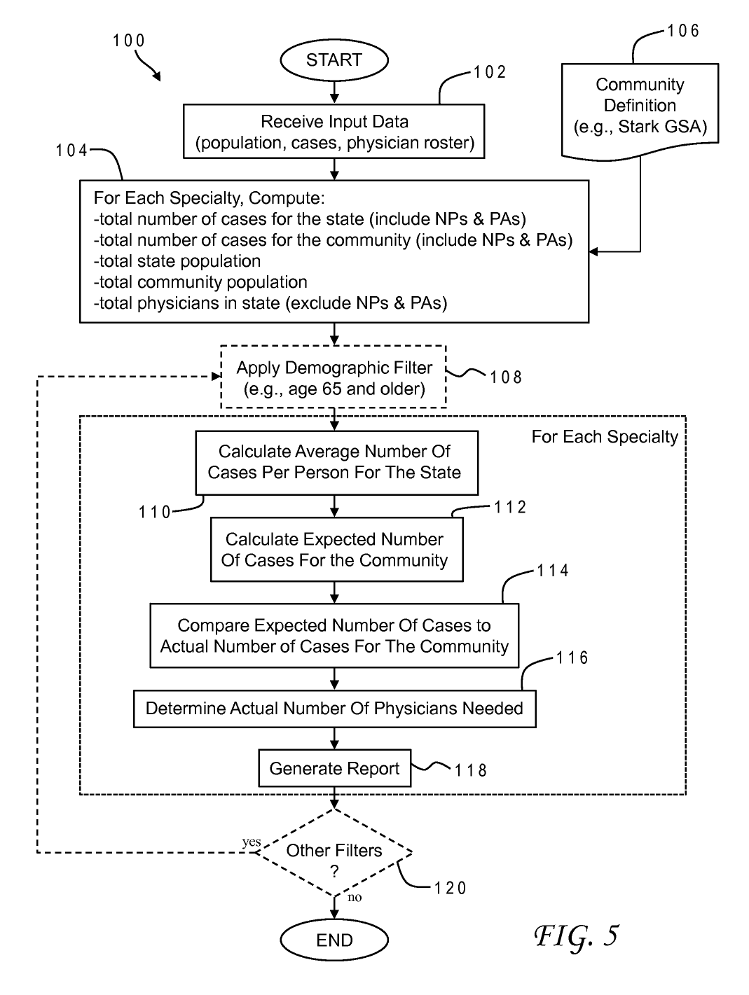

The present invention may be further understood with reference to the chart of FIG. 5 which illustrates the logical flow for a community needs assessment process 100 in accordance with some implementations. Process 100 may be carried out using computer system 10, and begins by receiving the various input files including population information, case information, and physician information 102. For each specialty, the analysis parameters are computed using the provided raw data 104, based upon a particular community definition 106, such as a Stark-defined GSA for a hospital. A demographic filter may optionally be applied to the transformed data 108. While the demographic filter may pertain to Medicare, i.e., using information only for patients 65 years and older, the filter can be based on any demographic or demographic combination. For example, the hospital might want to consider the needs of white females ages 0-4 years. After applying the filter, a number of calculations are performed for each specialty, beginning with the average number of cases per person for the state 110, which is then used to calculate the expected number of cases for the community 112. These two values are compared 114 to determine the actual number of physicians needed for the community 116. Computer system 10 can then generate a report to be used as a CNA itself or as a component of a CNA 118. If other filters are desired 120, the process repeats at box 108 with the application of different demographic constraints.

The present invention thereby provides a superior model to analyze the level of healthcare people receive in the community, compared to the level of healthcare received by the average person in a given state. This approach ensures that every community will have enough physicians to deliver a level of healthcare which is at least equal to the average level in the state.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, the larger geographic region that is used for benchmarking the community needs in the illustrative implementation is the state in which the GSA is located, but the region could be smaller or larger than the state (e.g., the 48 contiguous United States), or could transcend state boundaries, in which case the region could comprise either of multiple states or a combination of states. The region might even be defined by other than political boundaries, e.g., natural features such as rivers. It is therefore contemplated that such modifications can be made without departing from the spirit or scope of the present invention as defined in the appended claims.

What is claimed is:

1. A method of analyzing healthcare received in a geographic community for a physician specialty comprising:
calculating an average number of cases per person for the specialty in a geographic region which includes and is larger than the geographic community, by executing first instructions in a computer system;
calculating an expected number of cases for the specialty in the geographic community based on the average number of cases per person for the specialty in the geographic region, by executing second instructions in the computer system; and
comparing the expected number of cases for the specialty in the geographic community to a number of actual cases for the specialty in the geographic community, by executing third instructions in the computer system.

2. The method of claim 1 wherein the average number of cases per person for the specialty in the geographic region is calculated by dividing a total number of actual cases for the specialty within the geographic region by a population of the geographic region.

3. The method of claim 1 wherein the expected number of cases for the specialty in the geographic community is calculated by multiplying the average number of cases per person for the specialty in the geographic region by a population of the geographic community.

4. The method of claim 1 wherein the geographic community is a contiguous service area surrounding a hospital, and the geographic region is a state containing the contiguous service area.

5. The method of claim 1 wherein the average number of cases per person for the specialty in the geographic region and the expected number of cases for the specialty in the geographic community are filtered according to at least one patient demographic.

6. The method of claim 5 wherein the patient demographic is age.

7. The method of claim 1 wherein said comparing includes subtracting the expected number of cases for the specialty in the geographic community from the number of actual cases for the specialty in the geographic community to yield a community utilization differential.

8. The method of claim 7 further comprising dividing the community utilization differential by an average physician productivity for the specialty within the geographic region to determine an actual number of physicians needed for the specialty within the geographic community.

9. The method of claim 8 wherein the expected number of cases for the specialty in the geographic community and the number of actual cases for the specialty in the geographic community are based in part on services performed by non-doctor healthcare professionals, but the average physician productivity is based on a physician count which excludes non-doctor healthcare professionals.

10. A computer system comprising:
one or more processors which process program instructions;
a memory device connected to said one or more processors; and
program instructions residing in said memory device for analyzing healthcare received in a geographic community for a physician specialty by calculating an average number of cases per person for the specialty in a geographic region which includes and is larger than the geographic community, calculating an expected number of cases for the specialty in the geographic community based on the average number of cases per person for the specialty in the geographic region, and comparing the expected number of cases for the specialty in the geographic community to a number of actual cases for the specialty in the geographic community.

11. The computer system of claim 10 wherein the average number of cases per person for the specialty in the geographic region is calculated by dividing a total number of actual cases for the specialty within the geographic region by a population of the geographic region.

12. The computer system of claim 10 wherein the expected number of cases for the specialty in the geographic community is calculated by multiplying the average number of cases per person for the specialty in the geographic region by a population of the geographic community.

13. The computer system of claim 10 wherein the geographic community is a contiguous service area surrounding a hospital, and the geographic region is a state containing the contiguous service area.

14. The computer system of claim 10 wherein the average number of cases per person for the specialty in the geographic region and the expected number of cases for the specialty in the geographic community are filtered according to at least one patient demographic.

15. The computer system of claim 14 wherein the patient demographic is age.

16. The computer system of claim 10 wherein the comparing includes subtracting the expected number of cases for the specialty in the geographic community from the number of actual cases for the specialty in the geographic community to yield a community utilization differential.

17. The computer system of claim 16 wherein said program instructions further divide the community utilization differential by an average physician productivity for the specialty within the geographic region to determine an actual number of physicians needed for the specialty within the geographic community.

18. The computer system of claim 17 wherein the expected number of cases for the specialty in the geographic community and the number of actual cases for the specialty in the geographic community are based in part on services performed by non-doctor healthcare professionals, but the average physician productivity is based on a physician count which excludes non-doctor healthcare professionals.

19. A computer program product comprising:
a computer readable storage medium; and
program instructions residing in said storage medium for analyzing healthcare received in a geographic community for a physician specialty by calculating an average number of cases per person for the specialty in a geographic region which includes and is larger than the geographic community, calculating an expected number of cases for the specialty in the geographic community based on the average number of cases per person for the specialty in the geographic region, and comparing the expected number of cases for the specialty in the geographic community to a number of actual cases for the specialty in the geographic community.

20. The computer program product of claim 19 wherein the average number of cases per person for the specialty in the geographic region is calculated by dividing a total number of actual cases for the specialty within the geographic region by a population of the geographic region.

21. The computer program product of claim 19 wherein the expected number of cases for the specialty in the geographic community is calculated by multiplying the average number of cases per person for the specialty in the geographic region by a population of the geographic community.

22. The computer program product of claim 19 wherein the geographic community is a contiguous service area surrounding a hospital, and the geographic region is a state containing the contiguous service area.

23. The computer program product of claim 19 wherein the average number of cases per person for the specialty in the geographic region and the expected number of cases for the specialty in the geographic community are filtered according to at least one patient demographic.

24. The computer program product of claim 23 wherein the patient demographic is age.

25. The computer program product of claim 19 wherein the comparing includes subtracting the expected number of cases for the specialty in the geographic community from the number of actual cases for the specialty in the geographic community to yield a community utilization differential.

26. The computer program product of claim 25 wherein said program instructions further divide the community utilization differential by an average physician productivity for the specialty within the geographic region to determine an actual number of physicians needed for the specialty within the geographic community.

27. The computer program product of claim 26 wherein the expected number of cases for the specialty in the geographic community and the number of actual cases for the specialty in the geographic community are based in part on services performed by non-doctor healthcare professionals, but the average physician productivity is based on a physician count which excludes non-doctor healthcare professionals.
